(19) United States
(12) Patent Application Publication
(10) Pub. No.: US 2023/0268622 A1
(43) Pub. Date: Aug. 24, 2023

(54) BATTERY CELL

(71) Applicant: HONDA MOTOR CO., LTD., Tokyo (JP)

(72) Inventors: Takuya TANIUCHI, Saitama (JP); Masahiro OHTA, Saitama (JP)

(21) Appl. No.: 18/308,682

(22) Filed: Apr. 28, 2023

Related U.S. Application Data
(63) Continuation of application No. 17/148,588, filed on Jan. 14, 2021.

(30) Foreign Application Priority Data
Jan. 24, 2020 (JP) 2020-009821

(51) Int. Cl. H01M 50/533; H01M 10/058; H01M 10/0562

(52) U.S. Cl. CPC H01M 50/533; H01M 10/0562; H01M 10/058

(57) ABSTRACT

Provided is a battery cell that can effectively overcome problems caused by known battery cells having an outer jacket constituted by one folded film. A battery cell includes a battery, and an outer jacket accommodating the battery. At least one end face of the battery is connected to a current-collecting tab lead. The outer jacket is constituted by one film which is folded along another end face of the battery different from the end face connected to the current-collecting tab lead, and end portions of which are joined to each other such that the current-collecting tab lead is sandwiched between the end portions. The outer jacket has a hole at a position adjacent to the end face connected to the current-collecting tab lead, the hole being blocked.

### CROSS-REFERENCE TO RELATED APPLICATION

This application is a continuation of U.S. Application Serial Number 17/148,588, filed on Jan. 14, 2021, which claims the benefit of priority from Japanese Patent Application No. 2020-009821, filed on Jan. 24, 2020, the content of which is incorporated herein by reference.

### BACKGROUND OF THE INVENTION

### Field of the Invention

The present invention relates to a battery cell.

### Related Art

Recently, there has been a rapid increase in the demand for batteries with high capacity and high output, due to the widespread use of electrical devices and electronic devices of various sizes, such as automobiles, personal computers, and cellular phones. Examples of such batteries include an electrolyte solution-based battery cell including an organic electrolyte solution as an electrolyte between a positive electrode and a negative electrode, and a solid-state battery cell including a flame-retardant solid electrolyte as an electrolyte, instead of an organic electrolyte solution.

A laminate cell-type battery has been known which includes the above-described type of battery enclosed in, and sealed by, a laminate film (outer jacket), and which has a plate shape. A plurality of such laminate cell-type batteries are arrayed and housed in a casing to form a battery cell assembly for use in electric vehicles (EVs), hybrid electric vehicles (HEVs), etc. Enclosing a battery in an outer jacket makes it possible to prevent the ingress of air into the battery (e.g., Patent Document 1).

In order to effectively increase the volumetric energy density of a battery module while maintaining airtightness of a laminate film (outer jacket), a disclosed battery cell includes an outer jacket constituted by one film that is folded to accommodate a battery (Patent Document 2). According to Patent Document 2, the battery cell can effectively increase the volumetric energy density of a battery module while maintaining the airtightness of the outer jacket.
Patent Document 1: Japanese Unexamined Patent Application, Publication No. 2012-169204
Patent Document 2: PCT International Publication No. WO2019/188825

### SUMMARY OF THE INVENTION

An electrolyte solution-based battery cell including an electrolyte solution as an electrolyte may undergo aging during the production process. The aging can remove or deactivate impurities contained in electrode bodies. During the aging, a reactant gas may be generated.

In a case where such an electrolyte solution-based battery cell is enclosed between two films and the four sides of one of the films and the opposite four sides of the other are joined to each other to seal the battery, the reactant gas can be released from the joint surfaces at the time of the aging.

However, if the outer jacket has the configuration disclosed in Patent Document 2 (WO2019/188825), in which one film is folded along an end face of the battery, the four sides of the outer jacket does not have such joint surfaces. As a result, no escape path is provided for the reactant gas, so that the battery cell swells due to the reactant gas in some cases.

In the case of a solid-state battery cell including a flame-retardant solid electrolyte, the output properties of the solid-state battery cell are improved by way of integrating a stack of electrode layers and solid electrolyte layers, the integration being achieved by pressing the stack during the production process. At this time, performing the pressing for integration in parallel with evacuation of an outer jacket in which the stack has been inserted inhibits formation of dead space, whereby the volumetric energy density of a battery module is effectively increased. In addition, the stack forming the solid-state battery can be more firmly fastened by the outer jacket, thereby further improving the output properties of the battery.

However, in the case where the outer jacket is constituted by one film folded along an end face of the battery, it is not always easy to evacuate the inside of the outer jacket.

As can be seen, a battery cell having the configuration, in which one film constituting the outer jacket is folded to accommodate a battery while opposite end portions of the film are joined to each other, can effectively increase the volumetric energy density of a battery module while maintaining the airtightness of the outer jacket. On the other hand, application of this configuration to an electrolyte solution-based battery cell including an organic electrolyte solution and a solid-state battery cell including a solid electrolyte may cause the problems described above.

It is an object of the present invention to provide a battery cell which effectively overcomes the problems caused by the known battery cells including an outer jacket constituted by one folded film.

The present inventors have conducted intensive studies to achieve the present invention based on the findings that the above object can be achieved by a battery cell including a battery and an outer jacket having a blocked hole at a position adjacent to an end face of the battery connected to a current-collecting tab lead.

One aspect of the present invention provides a battery cell including a battery and an outer jacket accommodating the battery. At least one end face of the battery is connected to a current-collecting tab lead. The outer jacket is constituted by one film which is folded along another end face of the battery different from the end face connected to the current-collecting tab lead, and end portions of which are joined to each other such that the current-collecting tab lead is sandwiched between the end portions. The outer jacket has a hole at a position adjacent to the end face connected to the current-collecting tab lead, the hole being blocked.

This feature makes it possible to effectively overcome the problems caused by the known battery cells including an outer jacket constituted by one folded film.

The hole being blocked may be positioned on the current-collecting tab lead.

The hole being blocked may have a diameter smaller than a width of the current-collecting tab lead.

The battery may be an electrolyte solution-based battery including an electrolyte solution as an electrolyte.

The battery may be a solid-state battery including a solid electrolyte as an electrolyte.

Another aspect of the present invention provides a method of producing an electrolyte solution-based battery cell. The method includes: an outer jacket forming step in which an electrolyte solution-based battery having a current-collecting tab lead connected to at least one end face thereof is provided, a film is folded along another end face of the electrolyte solution-based battery different from the end face connected to the current-collecting tab lead such that the electrolyte solution-based battery is received in the folded film, and end portions of the folded film are joined to each other such that the current-collecting tab lead is sandwiched between the end portions, so that an outer jacket constituted by the folded film is formed; an aging step in which the electrolyte solution-based battery that has undergone the outer jacket forming step is left standing for a predetermined period of time; and a hole blocking step in which a hole of the outer jacket is blocked after the aging step.

Yet another aspect of the present invention provides a method of producing a solid-state battery cell. The method includes: an outer jacket forming step in which a solid-state battery having a current-collecting tab lead connected to at least one end face thereof is provided, a film is folded along another end face of the solid-state battery different from the end face connected to the current-collecting tab lead such that the solid-state battery is received in the folded film, and end portions of the folded film are joined to each other such that the current-collecting tab lead is sandwiched between the end portions, so that an outer jacket constituted by the folded film is formed; a pressing-integration step in which the solid-state battery is pressed in parallel with degassing through a hole formed in the outer jacket; an aging step in which the solid-state battery that has undergone the pressing-integration step is left standing for a predetermined period of time; and a hole blocking step in which the hole of the outer jacket is blocked after the pressing-integration step.

The present invention can effectively overcome the problems caused by the known battery cells including an outer jacket constituted by one folded film.

### BRIEF DESCRIPTION OF THE DRAWINGS

FIG. 1 is a perspective view showing a battery cell 1 according to an embodiment;

FIGS. 2A and 2B show cross sections of batteries each forming part of a battery cell according to an embodiment; and

FIG. 3A shows flowcharts illustrating methods of producing the electrolyte solution-based battery cell s according to the embodiments. FIG. 3B shows flowcharts illustrating methods of producing the solid-state battery cells according to the embodiments.

### DETAILED DESCRIPTION OF THE INVENTION

Specific embodiments of the present invention will be described in detail. It should be noted that the present invention is not in the least limited to the following embodiments, but can be worked together with appropriate modifications made within the scope of the object of the present invention.

### Overall Configuration of Battery Cell

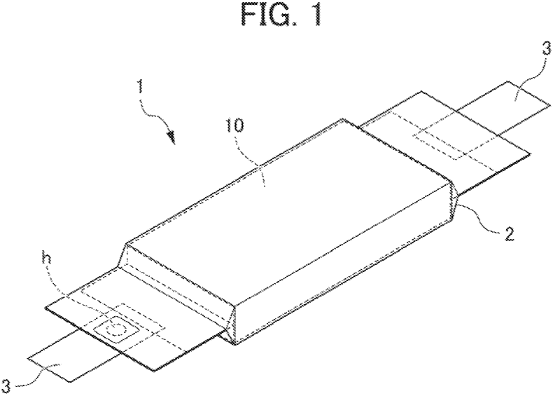

As shown in FIG. 1, a battery cell 1 according to an embodiment of the present invention includes a battery 10 and an outer jacket 2 that accommodates the battery 10. End faces of the battery 10 are each connected to a current-collecting tab lead 3 that functions as an outlet from which electricity is taken. End portions of a film that constitutes the outer jacket 2 are joined to each other by sandwiching the current-collecting tab leads 3.

The outer jacket 2 of the battery cell 1 has a hole h at a position adjacent to the end face connected to the current-collecting tab lead 3, the hole h being blocked. This configuration in which the hole h is formed at the position adjacent to the end face connected to the current-collecting tab 3 that is sandwiched between joined end portions of the film can effectively overcome problems caused by the known battery cells including an outer jacket constituted by a folded film. The hole h is formed by a known method such as punching, cutting, and laser processing.

Since the hole h is blocked by sealing or the like, the battery 10 can be hermetically accommodated in the outer jacket 2.

The battery of the present invention may be an electrolyte solution-based battery cell (first embodiment) including an electrolyte solution as an electrolyte or a solid-state battery cell (second embodiment) including a solid electrolyte. The electrolyte solution-based battery cell and the solid-state battery cell will be described later.

In the following, an outer jacket will be described which is applicable to both the electrolyte solution-based battery cell including the electrolyte solution as the electrolyte and the solid-state battery cell including the solid electrolyte.

### Outer Jacket

The outer jacket 2 is configured to accommodate the battery 10. Hermetically accommodating the battery 10 in the outer jacket 2 makes it possible to prevent the ingress of air into the battery 10.

Specifically, the outer jacket 2 is constituted by one film that is folded along one end face of the battery 10 so as to accommodate the battery 10 having a rectangular shape in planar view. End portions of the film are joined to each other such that the current-collecting tab lead 3 is sandwiched between the end portions. In comparison with a battery cell in which a battery is enclosed between two films and the four sides of one of the films and the opposite four sides of the other are joined to each other so that the battery is sealed by the four junctions, the battery cell with the outer jacket 2 has a reduced number of junctions of portions of the film and can inhibit formation of dead space. Thus, the battery cell with the outer jacket 2 effectively contributes to an increase in volumetric energy density of a battery module.

The end face for connection with the current-collecting tab lead 3 may be configured to have two current-collecting tab leads 3 connected thereto. Alternatively, as shown in FIG. 1, each of the two end faces may be configured to have one current-collecting tab lead 3 connected thereto.

The current-collecting tab lead 3 has an end portion exposed from the outer jacket 2, the end portion being located opposite to the end connected to the end face of the battery. Electricity can be taken from the exposed end portion of the current-collecting tab lead 3.

A junction of end portions of the film may be present at an end face other than the end faces connected to the current-collecting tab leads 3. Nevertheless, it is preferable that the junction is not positioned at an end face other than the end faces connected to the current-collecting tab leads 3, as in, for example, the battery cell 1 shown in FIG. 1. Avoiding positioning the junction of portions of the film at an end face of the battery makes it possible to more effectively increase the volumetric energy density of the battery module.

Examples of the outer jacket constituted by one folded film are disclosed in Patent Document 2 (WO2019/188825) (e.g., the outer jackets disclosed in FIGS. 1 to 10 of Patent Document 2).

The outer jacket 2 of the present embodiment has, as a feature, the blocked hole h at a position adjacent to the end surface connected to the current-collecting tab lead 3. The hole h before being blocked allows a reactant gas generated during an aging step included in a method of producing the electrolyte solution-based battery cell to be discharged therethrough, thereby making it possible to effectively inhibit the battery cell from swelling. Further, during a pressing-integration step included in a method of producing the solid-state battery cell, the presence of the hole h before being blocked enables the pressing to be performed in parallel with evacuation of the inside of the outer jacket via the hole h, thereby contributing to improvement of the output property of the battery.

The hole h is blocked in a later process step, whereby the ingress of air into the battery 10 can be prevented.

The position where the hole h is formed is not particularly limited, as long as the position is adjacent to the end face connected to the current-collecting tab lead. However, the hole h is preferably positioned on the current-collecting tab lead 3. It is more preferable that the hole h has a diameter smaller than the width of the current-collecting tab lead 3. Positioning the hole h on the current-collecting tab lead makes it advantageously easy to perform sealing by pressing another film onto the current-collecting tab lead 3.

The hole h is not limited to any particular shape, and may be substantially circular or elliptical, or may be polygonal. The hole h preferably has a diameter of ϕ0.1 mm or more and ϕ10 mm or less.

The number of holes h is not particularly limited, and may be 1 or 2 or more.

### (Film Constituting Outer Jacket)

Any film may be used as the outer jacket 2, as long as the film can constitute the outer jacket 2 that accommodates the battery 10. It is preferable that the film constituting the outer jacket 2 is such a film that can impart airtightness to the outer jacket 2.

The film constituting the outer jacket 2 preferably includes a barrier layer made of, for example, an inorganic thin film such as aluminum foil, or an inorganic oxide thin film such as a silicon oxide thin film or an aluminum oxide thin film. Inclusion of the barrier layer can impart airtightness to the outer jacket 2.

The film constituting the outer jacket 2 preferably includes a sealing layer made of a flexible resin such as a polyethylene resin. Portions of the sealing layer as part of the laminate of the film are made to face each other and welded to join each other. This feature eliminates the need for a process step of applying an adhesive. Note that the film constituting the outer jacket 2 does not have to include the sealing layer. The outer jacket 2 can also be formed by bonding portions of the film to each other with an adhesive.

Non-limiting examples of the film constituting the outer jacket 2 include a laminate in which a base layer made of polyethylene terephthalate, polyethylene naphthalate, nylon, polypropylene, or the like, the barrier layer described above, and the sealing layer described above are stacked on each other. These layers may be stacked with a known adhesive interposed therebetween, or may be stacked by, for example, an extrusion coating method, for example.

A preferred thickness of the film constituting the outer jacket 2 varies depending on the materials forming the film, but is preferably 50 µm or greater, and more preferably 100 µm or greater. A preferred thickness of the film constituting the outer jacket 2 is preferably 700 µm or less, and more preferably 200 µm or less.

The one film constituting the outer jacket 2 may be a single-layer film or a laminate including a plurality of layers stacked on each other.

The one film may be a planar film having a polygonal shape (e.g., a rectangular shape). Alternatively, the one film may have a cylindrical shape.

In the following, the electrolyte solution-based battery cell (first embodiment) including an organic electrolyte solution as an electrolyte and the solid-state battery cell (second embodiment) including a solid electrolyte will be described.

### <Battery Cell of First Embodiment>

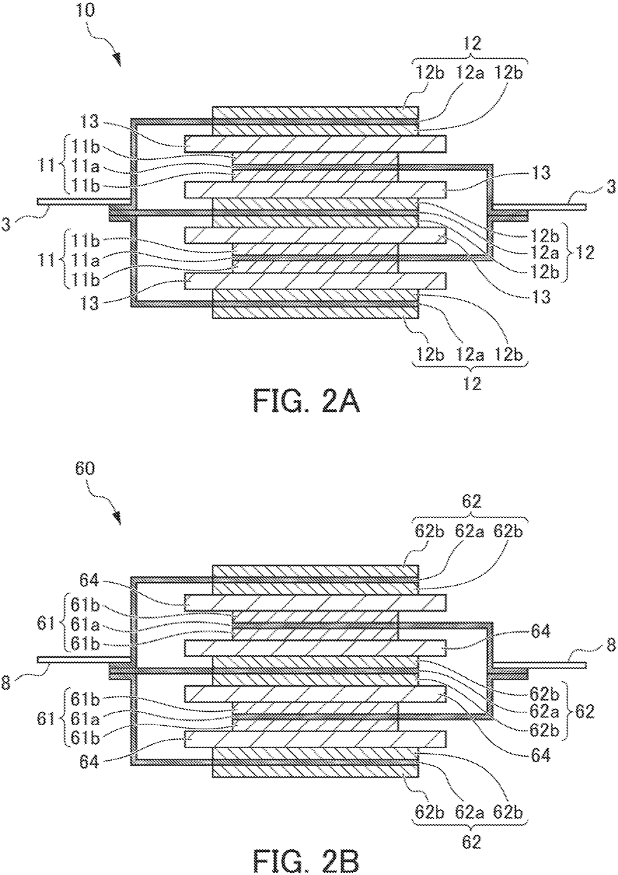

FIG. 2A is a cross-sectional view showing an overall configuration of a battery 10 according to the present embodiment. The battery cell 1 includes the battery 10 and the outer jacket 2 constituted by one film and accommodating the battery 10.

The battery 10 according to the present embodiment is an electrolyte solution-based battery including an organic electrolyte solution as an electrolyte. The battery 10 includes a plurality of positive electrodes 11, a plurality of negative electrodes 12, and a plurality of separators 13 impregnated with the electrolyte solution such that the positive electrodes 11 and the negative electrodes 12 alternate with each other with the separators 13 interposed therebetween. Current-collecting tab leads 3 are each connected to the positive electrodes 11 and the negative electrodes 12. As in the battery 10 according to the present embodiment, a configuration in which no insulator (no insulating layer) is provided between electrolyte solution-based battery cells can improve the energy density of the battery.

The battery (electrolyte solution-based battery) of the present invention is not limited to the battery in which a plurality of positive electrodes and a plurality of negative electrodes alternate with each other, but may be, for example, an electrolyte solution-based battery including one positive electrode and one negative electrode. Alternatively, the battery (electrolyte solution-based battery) of the present invention may have a laminate configuration in which a plurality of electrolyte solution-based battery cells are stacked one above the other with an insulator (insulating layer) interposed between adjacent ones of the battery cells.

The positive electrode 11 includes a positive-electrode current collector 11a and at least one positive electrode layer 11b formed on at least one surface of the positive-electrode current collector 11a, and is disposed such that the positive electrode layer 11b faces the separator 13.

The positive-electrode current collector 11a is not particularly limited, as long as it has a function of collecting a current of the positive electrode layer 11b. Non-limiting examples of a material for the positive-electrode current collector 11a include aluminum, aluminum alloys, stainless steel, nickel, iron, and titanium, among which aluminum, aluminum alloys, and stainless steel are preferred. Non-limiting examples of a shape or a state of the positive-electrode current collector 11a include a foil shape, a plate shape, a mesh shape, and a foam state, among which the foil shape is preferred.

The positive electrode layer 11b is a layer containing at least a positive-electrode active material. As the positive-electrode active material, a known material capable of releasing and storing ions (e.g., lithium ions) may be appropriately selected and used. Specific examples of the positive-electrode active material include, but are not limited to: lithium cobaltate (LiCoO₂); lithium nickelate (LiNiO₂) ; LiNiₚMn_{q}CoᵣO₂ (wherein p + q + r = 1) ; LiNiₚAl_{q}CoᵣO₂ (wherein p + q + r = 1); lithium manganate (LiMn₂O₄); hetero element-substituted Li—Mn spinel represented by Li₁+xMn₂—x—yMyO₄ (wherein x + y = 2, and M is at least one selected from Al, Mg, Co, Fe, Ni, and Zn); and metallic lithium phosphate (LiMPO₄, wherein M is at least one selected from Fe, Mn, Co, and Ni) .

The negative electrode 12 includes a negative-electrode current collector 12a and at least one negative electrode layer 12b formed on at least one surface of negative-electrode current collector 12a, and is disposed such that the negative electrode layer 12b faces the separator 13.

The negative-electrode current collector 12a is not particularly limited, as long as it has a function of collecting a current of the negative electrode layer 12b. Non-limiting examples of a material for the negative-electrode current collector 12a include nickel, copper, and stainless steel. Non-limiting examples of a shape or a state of the negative-electrode current collector 12a include a foil shape, a plate shape, a mesh shape, and a foam state, among which the foil shape is preferred.

The negative electrode layer 12b is a layer containing at least a negative-electrode active material. The negative-electrode active material is not particularly limited, as long as it is capable of releasing and storing ions (e.g., lithium ions). Non-limiting examples of the negative-electrode active material include: a lithium transition metal oxide such as lithium titanate (Li₄Ti₅O₁₂); a transition metal oxide such as TiO₂, Nb₂O₃, and WO₃; a metal sulfide; a metal nitride; a carbon material such as graphite, soft carbon, and hard carbon; metallic lithium; metallic indium; and lithium alloys. The negative-electrode active material may be in a powder form or a thin film form.

The separator 13 is made of, for example, a synthetic resin such as polyethylene. The electrolyte solution contains, for example, a solvent and a supporting electrolyte dissolved in the solvent. Non-limiting examples of the solvent include ethylene carbonate, propylene carbonate, dimethyl carbonate, and diethyl carbonate. Non-limiting examples of the supporting electrolyte include LiPF₆, LiBF₄, and LiClO₄. For a battery cell configured to include a gel electrolyte, it is preferable to use an electrolyte obtained by gelling a combination of an electrolyte solution and a polymer, such as polyvinylidene fluoride-hexafluoropropylene (PVDF-HFP), (poly)acrylonitrile, (poly)acrylic acid, or polymethyl methacrylate.

The current-collecting tab leads 3 are each connected to the positive electrodes 11 and the negative electrodes 12, and each extend from an end face of the battery 10. Materials usable for forming the current-collecting tab lead 3 are not particularly limited, and may be materials similar to those forming current-collecting tab leads of the known solid-state batteries.

### Method of Producing Battery Cell of First Embodiment

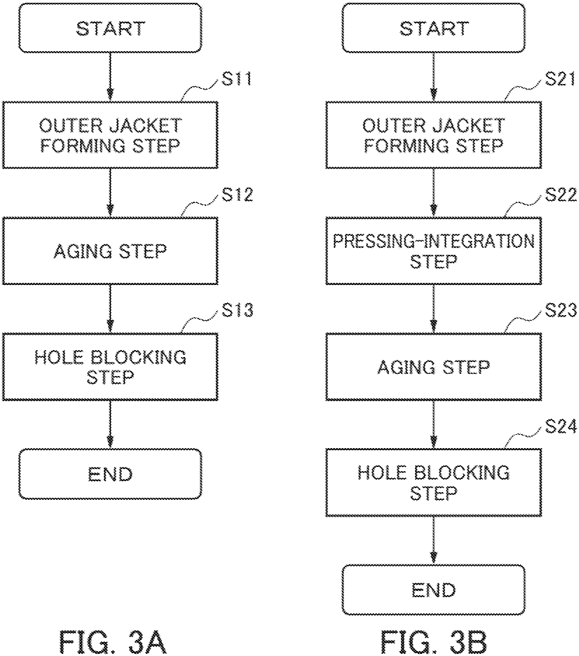

A method of producing the electrolyte solution-based battery cell includes, for example, the steps shown in the flowchart of FIG. 3A. Specifically, the method includes: (1) an outer jacket forming step S11 in which an electrolyte solution-based battery 10 having current-collecting tab leads 3 connected to at least one end face thereof is provided, a film is folded along another end face of the electrolyte solution-based battery 10 different from the end face connected to the current-collecting tab leads 3 such that the electrolyte solution-based battery 10 is received in the folded film, and end portions of the folded film are joined to each other such that the current-collecting tab leads 3 are sandwiched between the end portions, so that an outer jacket 2 constituted by the folded film is formed; (2) an aging step S12 in which the electrolyte solution-based battery 10 that has undergone the outer jacket forming step S11 is left standing for a predetermined period of time; and (3) a hole blocking step S13 in which a hole of the outer jacket is blocked after the aging step S12.

In the outer jacket forming step S11, for example, an outer jacket disclosed in Patent Document 2 (WO2019/188825) is formed. Specifically, the film including a barrier layer is folded along the end face of the battery 10, and the end portions of the film are joined such that the current-collecting tab lead 3 is sandwiched between the end portions. To join the film, opposite portions of a sealing layer of the laminate constituting the film may be joined to each other by heat welding or ultrasonic wave welding. Alternatively, opposite portions of the film may be joined to each other by a dry laminate method using an adhesive.

A hole h is formed in advance at a position to become adjacent to the end face connected to the current-collecting tab lead 3. The hole h is formed by a known method, such as punching, cutting, and laser processing. In the present embodiment, the outer jacket is constituted by a film having the pre-formed hole h. However, for example, following the formation of the outer jacket 2, a hole may be formed at a position adjacent to the end face connected to the current-collecting tab lead 3.

Note that not all the portions that need to be joined to form the outer jacket 2 have to necessarily be joined in the outer jacket forming step S11, and the joining may be performed after the aging step S12 is carried out. This applies to a method of producing the battery cell of the second embodiment to be described later (method of manufacturing the solid-state battery cell).

In the aging step S12, the electrolyte solution-based battery that has undergone the outer jacket forming step S11 is left standing for a predetermined period of time. At this time, the electrolyte solution-based battery is subjected to an initial charge and a chemical conversion treatment. In the aging step S12, a reactant gas may be generated from the electrolyte solution-based battery. In such a case, according to the present invention, the hole h formed in the outer jacket 2 enables effective discharge of the generated reactant gas.

In the aging step S12, the electrolyte solution-based battery 10 is heated in a controlled manner, preferably at a heating temperature of 25° C. or higher and 120° C. or lower, and more preferably at a heating temperature of 40° C. or higher and 80° C. or lower. In the aging step S12, the heating time period (standing time period) of the electrolyte solution-based battery 10 is preferably 0.5 hours or longer and 48 hours or shorter, and more preferably 1 hour or longer and 24 hours or shorter. As a method of performing the chemical conversion treatment on the electrolyte solution-based battery 10, a method can be exemplified in which the electrolyte solution-based battery 10 is heated in a constant temperature oven.

After the aging step S12, end portions of the film may be joined to each other such that the hole h is positioned on the current-collecting tab lead. At this time, the inside of the outer jacket may be degassed as necessary.

In the hole blocking step S13, the hole h of the outer jacket 2 accommodating the electrolyte solution-based battery 10 that has undergone the aging step is blocked. As a result, airtightness of the outer jacket 2 is maintained, thereby making it possible to prevent the ingress of air into the electrolyte solution-based battery 10.

As a method of blocking the hole h, a method can be exemplified in which the film surface having the hole h formed therein is sealed with another film.

### <Battery Cell of Second Embodiment>

FIG. 2B is a cross-sectional view showing an overall configuration of a battery 60 according to the present embodiment. The battery 60 according to the present embodiment is solid-state battery cell including a solid electrolyte. The battery 60 includes a plurality of positive electrodes 61, a plurality of negative electrodes 62, and a plurality of solid electrolyte layers 64 such that the positive electrodes 61 and the negative electrodes 62 alternate with each other with the solid electrolyte layers 64 interposed therebetween. Current-collecting tab leads 8 are each connected to the positive electrodes 61 and the negative electrodes 62. As in the battery 60 according to the present embodiment, a configuration in which no insulator (no insulating layer) is provided between solid-state battery cells can improve the energy density of the battery.

The battery (solid-state battery) of the present invention is not limited to the battery in which a plurality of positive electrodes and a plurality of negative electrodes alternate with each other, but may be, for example, a solid-state battery including one positive electrode and one negative electrode. Alternatively, the battery (solid-state battery) of the present invention may have a laminate configuration in which a plurality of solid-state battery cells are stacked one above the other with an insulator (insulating layer) interposed between adjacent ones of the solid-state battery cells.

The positive electrode 61 includes a positive-electrode current collector 61a and at least one positive electrode layer 61b formed on at least one surface of the positive-electrode current collector 61a. The negative electrode 62 includes a negative-electrode current collector 62a and at least one positive electrode layer 62b formed on at least one surface of the negative-electrode current collector 62a. The current-collecting tab leads 8 are each connected to the positive electrodes 61 and the negative electrodes 62, and each extend from an end face of the battery 60.

The solid electrolyte layers 64 are each interposed between the positive electrode 61 and negative electrode 62, and contains at least a solid electrolyte material. The solid electrolyte layer 64 allows, through the solid electrolyte material contained therein, ion conduction (e.g., lithium ion conduction) to take place between a positive-electrode active material and a negative-electrode active material.

The solid electrolyte material is not particularly limited, as long as it has ion conductivity (e.g., lithium ion conductivity). Non-limiting examples of the solid electrolyte material include a sulfide solid electrolyte material, an oxide solid electrolyte material, a nitride solid electrolyte material, and a halide solid electrolyte material, among which the sulfide solid electrolyte material is preferred. This is because the sulfide solid electrolyte material is superior in ion conductivity to the oxide solid electrolyte material.

The components other than the solid electrolyte layers 64, i.e., the positive electrodes 61, the negative electrodes 62, the current-collecting tab leads 8 may be the same or similar to those of the above-described battery cell of the first embodiment (electrolyte solution-based battery).

### Method of Producing Battery Cell of Second Embodiment

A method of producing the solid-state battery cell includes, for example, the steps shown in the flowchart of FIG. 3B. Specifically, the method includes: (1) an outer jacket forming step S21 in which a solid-state battery 60 having current-collecting tab leads 8 connected to at least one end face thereof is provided, a film is folded along another end face of the solid-state battery 60 different from the end face connected to the current-collecting tab leads 8 such that the solid-state battery 60 is received in the folded film, and end portions of the folded film are joined to each other such that the current-collecting tab leads 8 are sandwiched between the end portions, so that an outer jacket constituted by the folded film is formed; (2) a pressing-integration step S22 in which the solid-state battery 60 is pressed in parallel with degassing through a hole of the outer jacket; (3) an aging step S23 in which the solid-state battery 60 that has undergone the pressing-integration step S22 is left standing for a predetermined period of time; and (4) a hole blocking step S24 in which the hole of the outer jacket is blocked after the pressing-integration step S22.

In the pressing-integration step S22, the solid-state battery 60 is pressed in parallel with degassing through the hole of the outer jacket. Performing the pressing in parallel with the removal of air (evacuation) from the inside of the outer jacket through the hole of the outer jacket in this manner can reduce unnecessary space, thereby improving energy density. In addition, the pressing causes the outer jacket to further firmly fasten the laminate of the solid-state battery, thereby contributing to improvement of output properties of the battery.

As a method of pressing the solid-state battery 60, a method can be exemplified in which the solid-state battery 60 as a laminate is pressed via the outer jacket 2, using a pressing machine. The pressing is performed preferably at a pressure of 0.1 MPa or higher and 2000 MPa or lower, and more preferably at a pressure of 0.2 MPa or higher and 1000 MPa or lower. The removal of air (evacuation) is performed preferably at a pressure of 0 MPa or higher and 0.01 MPa or lower, and more preferably at a pressure of 0.0001 MPa or higher and 0.001 MPa or lower.

In the aging step S23, the solid-state battery 60 that has undergone the pressing-integration step S22 is left standing for a predetermined period of time. At this time, the solid-state battery 60 is subjected to an initial charge and a chemical conversion treatment. In the aging step S23, the solid-state battery 60 is heated in a controlled manner, preferably at a heating temperature of 25° C. or higher and 280° C. or lower, and more preferably at a heating temperature of 40° C. or higher and 200° C. or lower. In the aging step S23, the heating time period (standing time period) of the solid-state battery 60 is preferably 0.5 hours or longer and 72 hours or shorter, and more preferably 1 hour or longer and 24 hours or shorter. As a method of performing the chemical conversion treatment on the solid-state battery 60, a method can be exemplified in which the solid-state battery 60 is heated in a constant temperature oven.

The steps other than the pressing-integration step S22 and the aging step S23, i.e., the outer jacket forming step S21 and the hole blocking step S24 are the same or similar to those of the method of producing the battery cell (electrolyte solution-based battery) of the first embodiment described above.

As described above, the battery cell of the present invention can effectively overcome the problems caused by the known battery cells having an outer jacket constituted by one folded film.

### EXPLANATION OF REFERENCE NUMERALS

1: Battery Cell
10: Battery (Electrolyte Solution-Based Battery)
11: Positive Electrode
11a: Positive-Electrode Current Collector
11b: Positive Electrode Layer (Positive-Electrode Active Material)
12: Negative Electrode
12a: Negative-Electrode Current Collector
12b: Negative Electrode Layer (Negative-Electrode Active Material)
13: Separator
60: Battery (Solid-State Battery)
61: Positive Electrode
61a: Positive-Electrode Current Collector
61b: Positive Electrode Layer (Positive-Electrode Active Material)
62: Negative Electrode
62a: Negative-Electrode Current Collector
62b: Negative Electrode Layer (Negative-Electrode Active Material)
64: Solid Electrolyte Layer
2: Outer Jacket
3: Current-Collecting Tab Lead
8: Current-Collecting Tab Lead
H: Hole

What is claimed is:

1. A method for producing a battery cell, the method comprising:
an outer jacket forming step in which a battery having a current-collecting tab lead connected to at least one end face of the battery is provided, a film is folded along an end face of the battery different from the end face connected to the current-collecting tab lead such that the battery is received in the folded film, and end portions of the folded film are joined to each other such that the current-collecting tab lead is sandwiched between the end portions, thereby forming an outer jacket having a hole at a position corresponding to the end face connected to the current-collecting tab lead;
an aging step in which the battery that has undergone the outer jacket forming step is left standing for a predetermined period of time; and
a hole blocking step in which the hole of the outer jacket is blocked after the aging step.

2. The method according to claim 1, wherein
in the outer jacket forming step, the hole is formed on the current-collecting tab lead.

3. The method according to claim 2, wherein
in the outer jacket forming step, the hole has a diameter smaller than a width of the current-collecting tab lead.

4. The method according to claim 1, wherein
the battery is an electrolyte solution-based battery including an electrolyte solution as an electrolyte.

5. The method according to claim 1, wherein
the battery is a solid-state battery including a solid electrolyte as an electrolyte,
the method further comprises a pressing-integration step in which the solid-state battery is pressed in parallel with degassing through a hole formed in the outer jacket, and
in the aging step, the solid-state battery that has undergone the pressing-integration step is left standing for a predetermined period of time.

6. The method according to claim 2, wherein
the battery is an electrolyte solution-based battery including an electrolyte solution as an electrolyte.

7. The method according to claim 2, wherein
the battery is a solid-state battery including a solid electrolyte as an electrolyte,
the method further comprises a pressing-integration step in which the solid-state battery is pressed in parallel with degassing through a hole formed in the outer jacket, and
in the aging step, the solid-state battery that has undergone the pressing-integration step is left standing for a predetermined period of time.

8. The method according to claim 3, wherein
the battery is an electrolyte solution-based battery including an electrolyte solution as an electrolyte.

9. The method according to claim 3, wherein
the battery is a solid-state battery including a solid electrolyte as an electrolyte,
the method further comprises a pressing-integration step in which the solid-state battery is pressed in parallel with degassing through a hole formed in the outer jacket, and
in the aging step, the solid-state battery that has undergone the pressing-integration step is left standing for a predetermined period of time.
